(19) United States
(12) Patent Application Publication
(10) Pub. No.: US 2021/0289609 A1
(43) Pub. Date: Sep. 16, 2021

(54) Programmable Smart Module

(71) Applicant: OPEN PLATFORM SYSTEMS LLS, Garden City, ID (US)

(72) Inventors: Dan Dina, Cocoa Beach, FL (US); Bob Deely, Garden City, ID (US); Ormond Rankin, Garden City, ID (US); George Walter Lewis, Garden City, ID (US)

(21) Appl. No.: 17/200,692

(22) Filed: Mar. 12, 2021

Related U.S. Application Data
(60) Provisional application No. 62/988,705, filed on Mar. 12, 2020.

(51) Int. Cl. H05B 47/19; H05B 47/11

(52) U.S. Cl. CPC H05B 47/19; H05B 47/11

(57) ABSTRACT

A Programmable Smart Module configured to recognize control and dimming standards provided by connected sensor(s) and wireless input control and to recognize the control and dimming standards of a driver connected to the Programmable Smart Module. The Programmable Smart Module is thus configured to accept the control and/or dimming standard and to provide control to the Driver in the standard the Driver accepts. The Programmable Smart Module allows for a single construct of a smart module to be utilized with a variety of control standards and/or Drivers. The Programmable Smart Module further include wireless functionality to provide for wireless programmability, wireless control of the Programmable Smart Module, and/or wireless control of other connected Programmable Smart Modules for the control of additional luminaires in a mesh network.

### PRIORITY/CROSS-REFERENCE TO RELATED APPLICATIONS

This application claims the benefit of U.S. Provisional Application No. 62/988,705, filed Mar. 12, 2020, and U.S. Nonprovisional application Ser. No. 17/189,189, filed Mar. 1, 2021, the disclosures of which are incorporated by reference.

### TECHNICAL FIELD

The disclosure generally relates to the field of power control for lighting applications. Particular embodiments relate to a smart accessory microcontroller for controlling, from a variety of control standards, light output in one or more LED lighting devices and/or lighting systems.

### BACKGROUND

The typical outdoor street or area light fixture does not have wireless connectivity to other lights or to the Internet. A variety of control standards exist for the control of the Driver (Power Supply) that provides power to the LED light of the light fixture. Typically a different controller is required for each control standard and each dimming standard. The inventors and the applicant are unaware of any device that in the art today that dynamically switches between these standards and between different driver models.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a Programmable Smart Module with microcontroller capable of receiving wireless communication in a mesh network and switching between industry standard control lines of the Driver (Power Supply). Different Drivers use different control standards and the Programmable Smart Module is capable of switching between these standards to support a wide range of Drivers. The disclosed Programmable Smart module can switch between control and dimming standards, including 0-10V, pulse width modulation (PWM), digital device interface (DDI) and DALI/DALI2/D4i industry standards.

The Programmable Smart Module is a Microcontroller design that makes use of its wireless connectivity capabilities to allow control interface programmability at the time of construction in the factory or at a customer site. This novel idea allows the use of a wireless connection (THREAD, BLE, WIFI, Cellular or other wireless network standards) to communicate control and monitoring data with multiple wired interface standards (DALI, DALI2, DDI, PWM, 0-10V) for lighting fixture Drivers. The Programmable Smart Module may have a GPS chip installed to allow location identification at installation and commissioning of the light fixture. The Programmable Smart Module supports several Digital and Analog control methods and interfaces seamlessly to a Driver and provides a wireless connection for mesh networking light fixtures together or connecting through a gateway to the Internet. For example, a traditional analog 0-10V dimming interface can be converted to a wireless signal and communicate to other lights in the mesh for dimming control. The wireless connectivity and mesh networking capability of the Programmable Smart Module makes it possible for other Programmable Smart Modules to communicate to each other for control of light fixture output and monitoring of light fixture status.

The Programmable Smart Module design makes use of its wireless connectivity capabilities to allow control interface programmability at the time of construction in the factory or at a customer site. This novel idea allows multiple interfaces to use the same physical connections on the Programmable Smart Module in order to support several Digital and Analog control methods which by definition are nonexistent in traditional connections. For example, the Analog Dimming function requires a control device to present an Analog Voltage level between the DIM+/DIM− terminals to the Driver, which when sampled by the Driver interface circuitry provides an indication of the Diming level needed to control the Voltage/Current delivery to the LED load. In this mode the full range of Light output is comprised of a voltage level in the range of 0-10V which using visual logarithmic levels determine how much light output to generate out of the light fixture being powered by a Driver.

An additional feature of the programmability, monitoring and change of Driver interface functionality proposed by this patent disclosure is that the Programmable Smart Module will be made virtually immune from installation error by assuring that the proper control communication method is selected based on the Driver installed in the fixture.

The disclosed microcontroller can be utilized in the manufacture of a variety of luminaires, reducing the number of different controllers necessary to fabricate different luminaires by allowing the programmability of a single controller across an array of different control and dimming standards.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF THE DRAWINGS

FIG. 1 illustrates a diagram of a Programmable Smart Module configured with a wireless connection.

FIG. 2 illustrates a preferred embodiment of a Programmable Smart Module having a Smart Microcontroller and an integrated sensor configured for attachment to a luminaire.

FIG. 3 illustrates an exploded view of a preferred embodiment of a Programmable Smart Module having a Smart Microcontroller and an integrated sensor configured for attachment to a luminaire.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

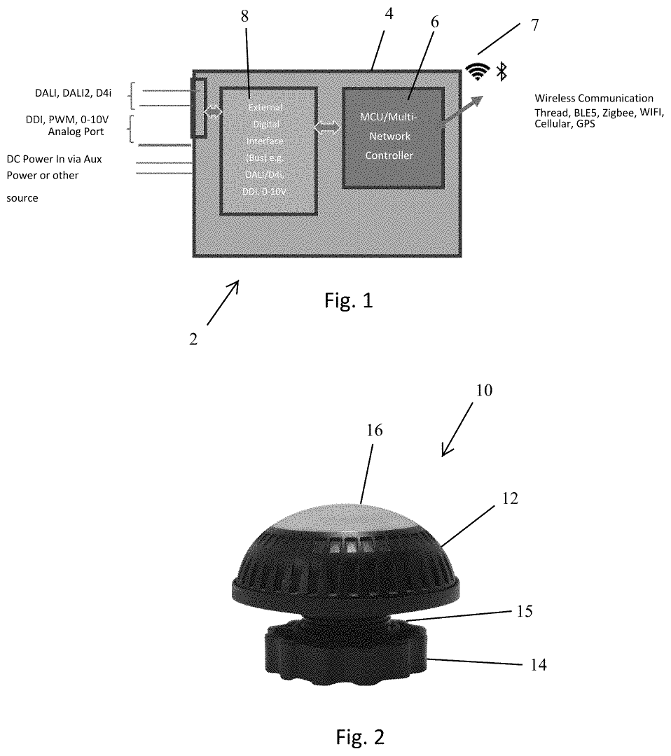

FIG. 1 illustrates a diagram of a preferred embodiment of a Programmable Smart Module 2. The Programmable Smart Module has a case 4 in which the electronics of the Programmable Smart Module are positioned. The Programmable Smart Module has external connections 8 from a control source, such as a sensor or dimmer. The Programmable Smart Module is configured to provide a dimming or control signal to a driver of a light. The Programmable Smart Module is configured to determine the control standard provided to the Programmable Smart Module, to determine the dimming standard of the driver of the light, and to provide a dimming and/or control signal to the driver of the light in response to the input control signal from the controller. The Programmable Smart Module is thus configured to ensure that the correct signal is provided to the driver, allowing for a variety of control standards and dimming standards to be utilized with a single SKU of a Programmable Smart Module.

The Programmable Smart Module is further configured for wireless communication 7 with other Programmable Smart Modules and/or other smart devices. This allows, for example, a single dimming or controller to interface with a single Programmable Smart Module, and for the single Programmable Smart Module to wirelessly provide a signal to other Programmable Smart Modules on the same network to control operation of additional lights.

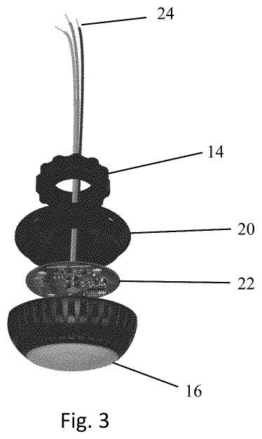

FIGS. 2 and 3 illustrate a preferred embodiment of a Programmable Smart Module with integrated sensor. The Programmable Smart Module has preferably a plastic housing 12 to facilitate wireless communication. In the depicted embodiment the housing is connected via a threaded lug 15 to a lock nut 14 for attachment to a luminaire. A base and gasket 20 protect the electronics 22 of the Programmable Smart Module from exterior damaging elements, such as rain or other liquid and environmental contaminants. The electronics include a wireless chip and antennae for connecting wirelessly to other devices and/or networks. A series of control lines and power source 24 provides power to the Programmable Smart Module and control connections to the light Driver. In the depicted embodiment, a photocell is provided for detecting ambient light conditions, however alternate sensors can be utilized or alternatively the Programmable Smart Module can be utilized without a sensor, and programmed and/or controlled via the wireless connection.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

We claim:

1. An intelligent microcontroller configured for the control of a luminaire, said microcontroller comprising:
a microcontroller module configured to control Driver interfaces to said luminaire Driver and light output of said luminaire, wherein said microcontroller is configured to control input to said luminaire Driver dynamically based on wireless input control, wherein said microcontroller is configured to switch dynamically between control standards and dimming standards;
and wherein said microcontroller is configured for wireless communication.

2. The intelligent microcontroller of claim 1, wherein said microcontroller is configured to dynamically switch between digital and analog light control standards by dynamically configuring said Dim+ and Dim− pins of said Driver to dynamically switch between digital and analog light control.

3. The intelligent microcontroller of claim 1, wherein said dimming standards comprise 0-10V, pulse width modulation, digital device interface and DALI/DALI2/D4i industry dimming standards.

4. The intelligent microcontroller of claim 1, wherein said microcontroller is configured with circuitry configured to detect if a driver connected to said Dim+ and said Dim− pins is controlled by digital or analog light control.

5. The intelligent microcontroller of claim 1, wherein said microcontroller comprises an integrated photocell.

6. The intelligent microcontroller of claim 1, wherein said microcontroller comprises an integrated occupancy sensor.

7. The intelligent microcontroller of claim 1, wherein said microcontroller is configured for connection to a photocell, occupancy sensor or other environmental sensor.

8. The intelligent microcontroller of claim 1, wherein said microcontroller is configured to receive a wireless signal from other wireless control devices, the Internet or other environmental sensors.

9. The intelligent microcontroller of claim 1, wherein said microcontroller circuitry comprises a GPS chip.

10. The intelligent microcontroller of claim 1, wherein said microcontroller circuitry comprises a cellular communication chip.
